(19) United States
(12) Patent Application Publication
(10) Pub. No.: US 2012/0258416 A1
(43) Pub. Date: Oct. 11, 2012

(54) METHOD TO DEFINE, MEASURE, AND DISPLAY MESIODISTAL ANGULATION AND FACIOLINGUAL INCLINATION OF EACH WHOLE TOOTH

(76) Inventor: Hongsheng Tong, Yorba Linda, CA (US)

(21) Appl. No.: 13/441,676

(22) Filed: Apr. 6, 2012

Related U.S. Application Data
(60) Provisional application No. 61/473,690, filed on Apr. 8, 2011.

(51) Int. Cl. A61C 19/04

(52) U.S. Cl. 433/24

(57) ABSTRACT

This is directed to systems, processes, machines, and other means that determine the mesiodistal angulation and the faciolingual inclination of each whole tooth in three-dimensional space in the field of orthodontics and displaying the results in constructed panoramic views.

### CROSS REFERENCE TO RELATED APPLICATIONS

This application claims priority to U.S. Provisional Patent Application 61/473,690 filed on Apr. 8, 2011 which is incorporated by reference in its entirety.

This invention relates to determining the mesiodistal angulation and the faciolingual inclination of each whole tooth in three-dimensional space in the field of orthodontics and displaying the results in constructed panoramic views.

### BACKGROUND OF THE INVENTION

One objective of orthodontic treatment is to obtain correct mesiodistal angulation (tip) and faciolingual inclination (torque) of all teeth in three-dimensional (3D) space at the end of treatment. Among all the effort of perfecting the orthodontic appliances, probably few surpass the contribution by Dr. Lawrence Andrews, who has contributed to the concept and design of pre-adjusted appliances most orthodontists use today. However, even experienced orthodontists found it difficult to achieve normal occlusion by using the pre-adjusted appliances, mostly due to inaccurate bracket positioning. Indirect bonding is known to increase bracket positioning accuracy. However, less than ideal crown or gingival anatomy may obscure the identification of the facial axes of the clinical crowns (FACC) and their center points (the FA points) necessary for accurate bracket positioning even on the stone models. Also clinical crowns are usually short relative to the roots. A mere 0.7 mm marginal ridge discrepancy for the crown would lead to a 10 degree error in the FACC and the root tip more than 3 mm off its proper position. Proper root alignment may provide assistance when orthodontists strive to finish cases to his/her best ability. For many orthodontists, imperfections in the crown alignment only become obvious after improper root angulations are detected on the X-rays. However, the pantomographs often used to check root alignment are not reliable. As for the faciolingual inclination of individual tooth, there is no other means to check. This is because the mesiodistal angulation and faciolingual inclination can only be measured in 3D, similar like Dr. Andrews did with the crowns on the stone models. The present invention includes systems and methods for measuring mesiodistal angulation and faciolingual inclination of each whole tooth (including root) using three-dimensional volumetric images generated from cone-beam computed tomographic scans, or any other scans that may generate 3D images of the dentofacial structures. The present invention also includes systems and methods for establishing a clinical three-dimensional (3D) standard for each whole tooth tip and torque.

### BRIEF SUMMARY OF THE INVENTION

The present invention includes methods, systems, and other means for defining, measuring and displaying each and every tooth mesiodistal angulation and faciodistal inclination in 3D space. A method for measuring and displaying teeth comprises locating a crown center of each tooth, which is an intersection of an anatomical mesiodistal plane, an anatomical faciolingual plane and an anatomical axial plane. Here, the anatomical axial plane is set at crown center level. Next, a user locates a root center of each tooth which is the intersection of the anatomical mesiodistal plane, the anatomical faciolingual plane and the anatomical axial plane. Here, the anatomical axial plane is set at a root center level. After that, a user can determine a long axis for each tooth by connecting the crown center of each tooth with the root center of each tooth.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 shows a diagram of a canine tooth which describes the terminology used in the invention.

FIG. 2 is a schematic flow chart of the invention.

FIG. 3 is a schematic flow chart of the invention and a continuation of FIG. 2.

FIG. 4A shows the digitization of an incisor crown center, root center and its long axis in its anatomical 3-plane coordinate from the anatomical mesiodistal plane view.

FIG. 4B shows the digitization of an incisor crown center, root center and its long axis in its anatomical 3-plane coordinate from the anatomical faciolingual plane view.

FIG. 4C shows the digitization of an incisor crown center, in its anatomical 3-plane coordinate from the anatomical axial plane view at the crown center level.

FIG. 4D shows the digitization of an incisor root center in its anatomical 3-plane coordinate from the anatomical axial plane view at the root center level.

FIG. 5A shows the digitization of a molar crown center, root center and its long axis in its anatomical 3-plane coordinate from the anatomical mesiodistal plane view.

FIG. 5B shows the digitization of a molar crown center, root center and its long axis in its anatomical 3-plane coordinate from the anatomical faciolingual plane view.

FIG. 5C shows the digitization of a molar crown center in its anatomical 3-plane coordinate from the anatomical axial plane view at the crown center level.

FIG. 5D shows the digitization of a molar root center in its anatomical 3-plane coordinate from the anatomical axial plane view at the root center level.

FIG. 6 -demonstrates setting up the non-anatomical three-perpendicular reference planes, relative to the dental arch for the measurement of the mesiodistal angulation and the faciolingual inclination.

FIG. 7 demonstrates how mesiodistal agulations are measured in the incisor and in the molar.

FIG. 8 demonstrates how faciolingual inclinations are measured in the incisor and in the molar.

FIG. 9 is a display of each tooth mesiodistal angulation in a constructed panoramic view.

FIG. 10 is a display of each tooth faciolingual inclination in a constructed panoramic view.

### DETAILED DESCRIPTION OF THE INVENTION

Embodiments of the present invention overcome many of the obstacles associated with measuring and displaying mesodistal angulation and faciolingual inclination of each whole tooth in 3D, and now will be described more fully hereinafter with reference to the accompanying drawings that show some, but not all embodiments of the claimed inventions. Indeed, the invention may be embodied in many different forms and should not be construed as limited to the embodiments set forth herein. Rather, these embodiments are provided so that this disclosure will satisfy applicable legal requirements. Like numbers refer to like elements throughout.

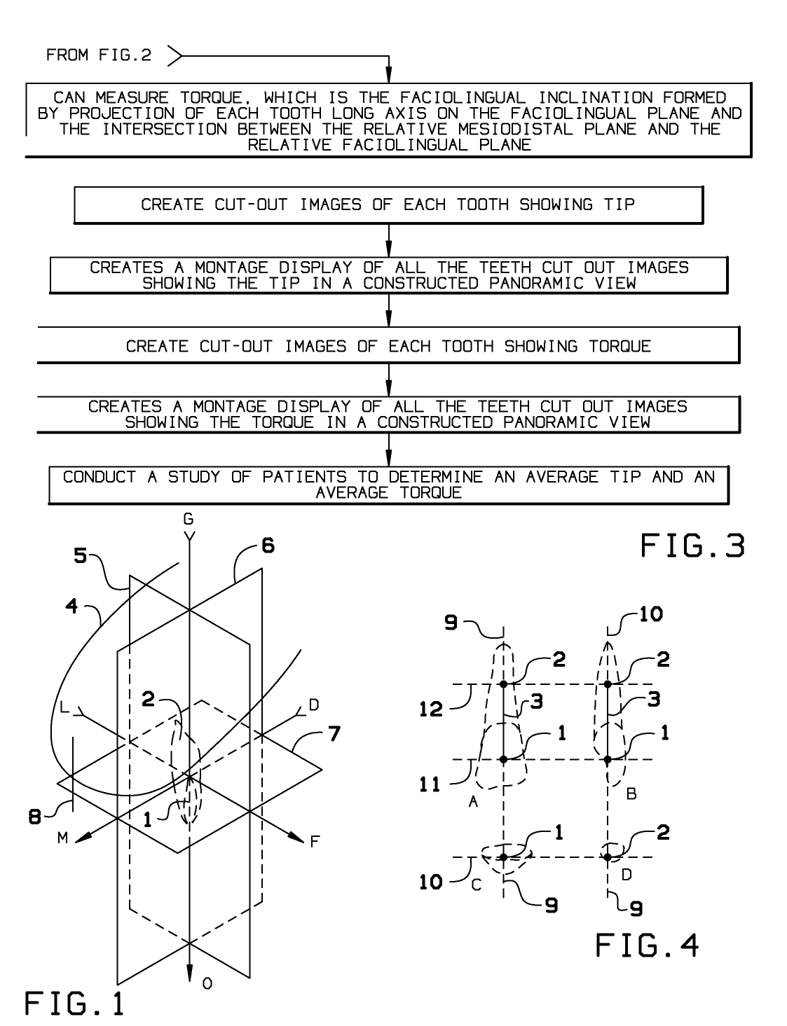

FIG. 1 shows a diagram of a tooth illustrating the dimensions of the tooth used in this application. Crown center 1 is the crown center of the tooth. Root center 2 is the root center of a tooth. Dental arch 4 is the dental arch. From the crown center 1 there is dental-arch-related mesio-distal (MD) axis, where M extends toward mesial or the dental arch center or the front of the dental arch. Similarly, D extends toward the distal or the back or away from the dental arch center. Additionally, there is arch-related facio-lingual (FL) axis, where F extends toward the facial (lip or cheek) side of the dental arch. Likewise, L extends toward the tongue or lingual side of the dental arch. There is also arch-related occluso-gingival (OG) axis, where O extends toward the biting or occlual surface of a tooth, and G extends toward the gum or gingival side of a tooth.

Turning these non-anatomical, dental-arch-related, tooth-specific axes into arch related two-dimensional planes, the arch-related faciolingual plane 5 is the plane that encompasses the FL axis and the OG axis, and that is perpendicular to the occlusal plane, and that is perpendicular to the dental arch. Similarly, arch-related mesiodistal plane 6 is the plane that encompasses the MD axis and the OG axis, and that is perpendicular to the arch-related facioingual plane and the occlusal plane; the arch-related occlusal plane 7 is the plane that encompasses the MD axis and the FL axis, and that is parallel to the dental arch plane at approximately the crown center level.

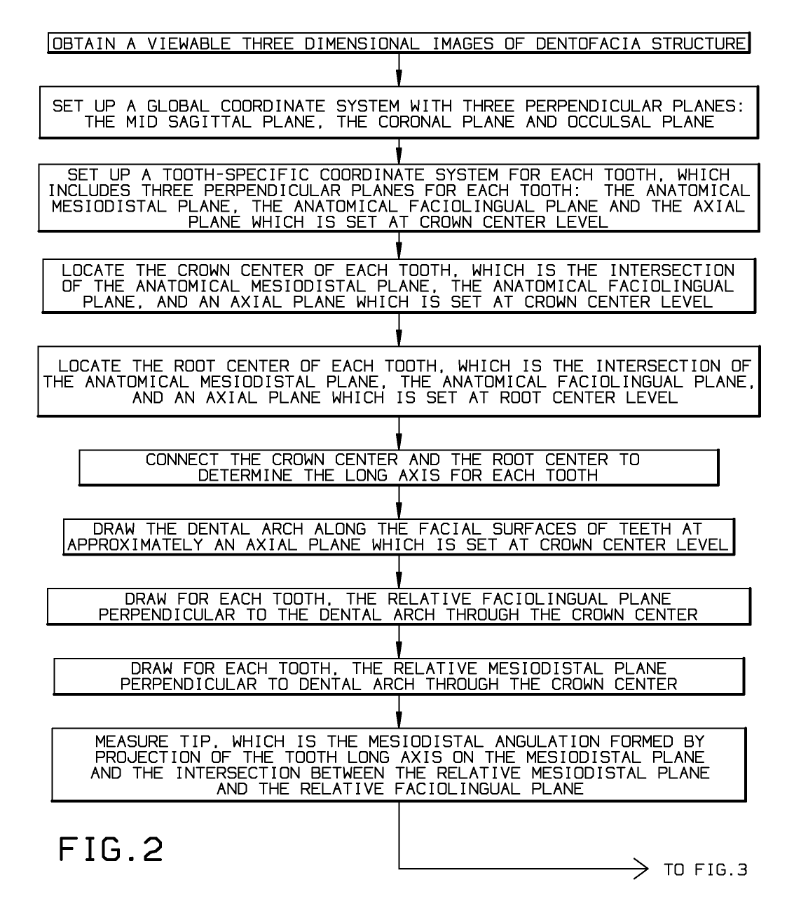

FIG. 2 shows the first ten steps in the method to define, measure and display mesiodistal angulation and faciolingual inclination of each whole tooth. These steps are not necessarily in any particular order and isolated steps can be used in many combinations, some of which are explained below.

In Step 1, the user can obtain viewable three dimensional images of dentofacial structures. The best example of such images are generated with the use of, but not limited to, cone-beam computed tomography (CBCT).

In Step 2, the user can set up a global coordinate system with three perpendicular planes: the mid-sagittal plane, the coronal plane and occlusal plane 7. The mid-sagittal plane evenly divides a right and level the left side of the mouth. The coronal plane crosses at the buccal groves of the upper first molars. Occlusal plane 7 is defined as the plane that intersected the incisal overbite and the molar overbite at the buccal grooves of the upper first molars. Both maxillary and mandibular transverse planes are parallel to occlusal plane 7 at the corresponding crown center 1 levels defined above.

In Step 3, the user can set up a tooth-specific coordinate system for each tooth, which includes three perpendicular planes for each tooth: Anatomical mesiodistal plane 10, anatomical faciolingual plane 9, and the anatomical axial plane which is set at either the crown center level 11, or the root center level 12.

In Step 4, the user can locate crown center 1 of each tooth, which is the intersection of anatomical mesiodistal plane 10 and anatomical faciolingual plane 9, and the anatomical axial plane which is set at crown center level 11. This is shown in more detail in FIG. 4A, 4B and 4C for an incisor and FIG. 5A, 5B and 5C for a molar. To do this, tooth images are rotated until the tooth images are orthogonal in all three plane views.

In Step 5, the user can locate root center 2 of each tooth, which is the intersection of anatomical mesiodistal plane 10 and anatomical faciolingual plane 9, and the anatomical axial plane which is set at root center level 12. This is shown in more detail in FIG. 4A, 4B, 4D for an incisor and FIG. 5A, 5B, 5D for a molar. Either the center of a single root or the center of the bi- or tri-furcation of a double or triple- rooted tooth is digitized in the anatomical axial plane view. For the digitization of the next tooth, a different 3-perpendicular-anatomical-plane coordinate specific only for the next tooth would be used.

In Step 6, the user can connect crown center 1 and root center 2 to determine long axis 3 for each tooth.

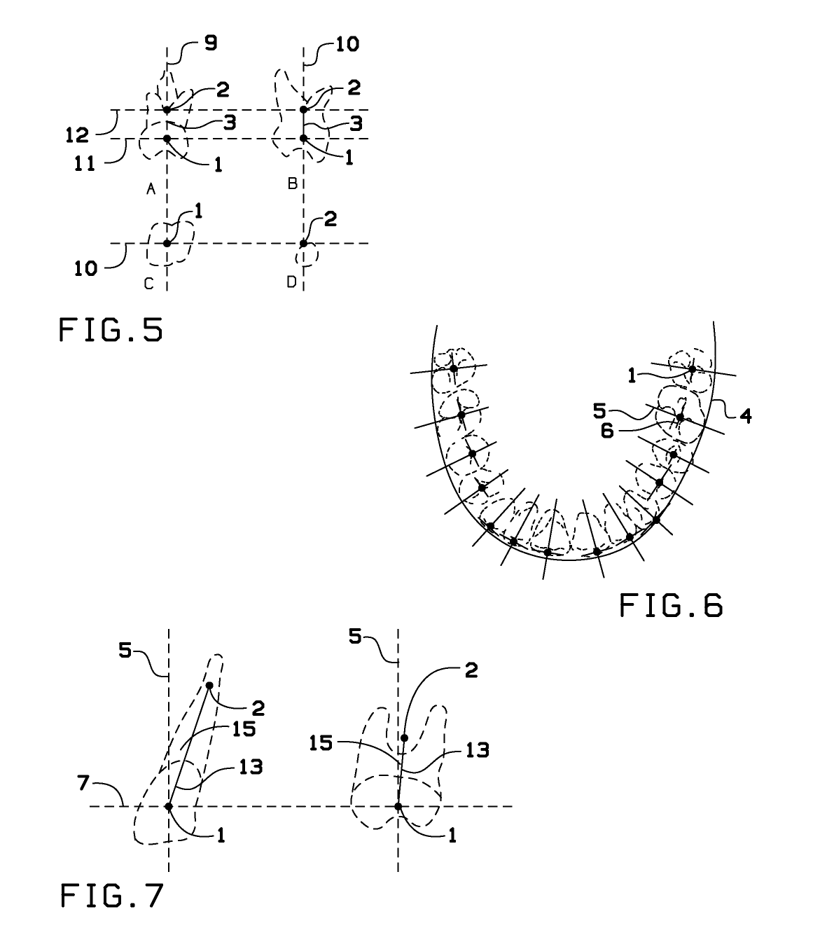

In Step 7, the user can draw dental arch 4 along the facial surfaces of all the teeth from the same arch at approximately the axial plane which is set at crown center level 11 as shown in FIG. 6.

In Step 8, the user can draw for each tooth, non-anatomical, arch-related faciolingual plane 5 through each tooth crown center 1, and perpendicular to dental arch 4. Here, the transverse plane is the same arch wire plane as in the global coordinate system.

In Step 9, the user can draw for each tooth, non-anatmical, arch-related mesiodistal plane 6 through each tooth crown center, and perpendicular to dental arch 4.

In Step 10, the user can measure tip 15, which is the mesiodistal angulation formed by projection of the tooth long axis on the mesiodistal plane 13 and the intersection between arch-related mesiodistal plane 6 and arch-related faciolingual plane 5 as shown in FIG. 7.

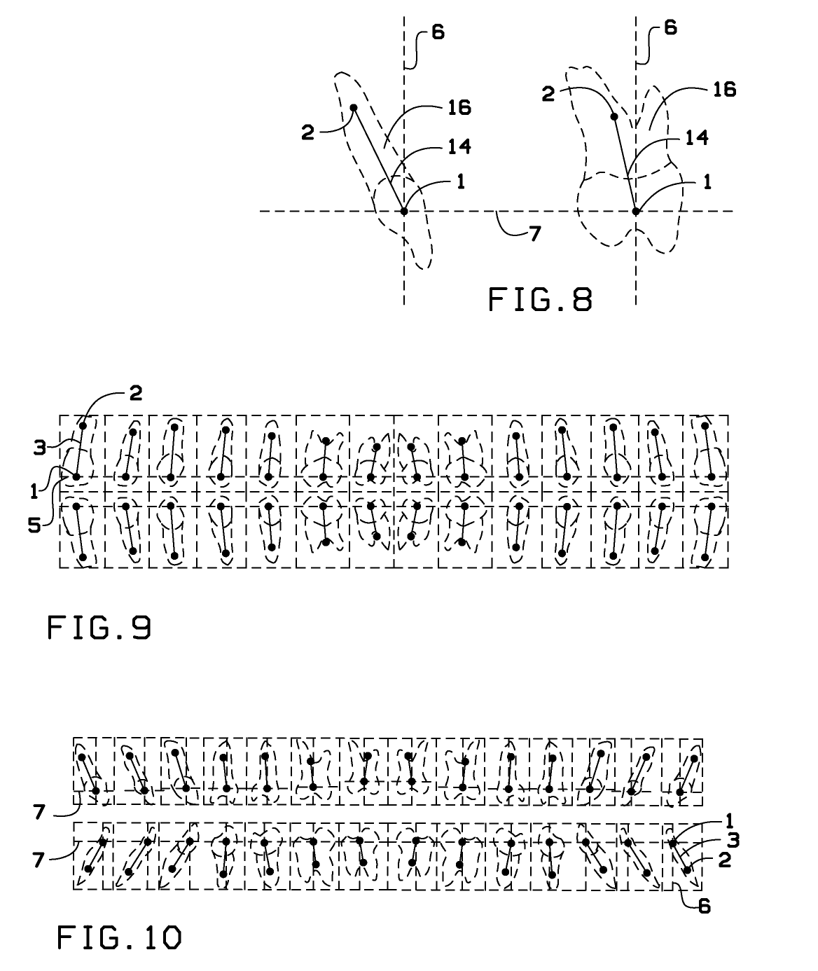

In Step 11 the user can measure torque 16, which is the faciolingual inclination formed by projection of each tooth long axis 14 on the faciolingual plane and the intersection between relative mesiodistal plane 14 and arch-related faciolingual plane 5 as shown in FIG. 8.

In Step 12, the user creates cut-out orthogonal images of each tooth showing tip 15.

In Step 13, the user creates a montage display of all the teeth cut out orthogonal images showing tip 15 in a constructed panoramic view as shown in FIG. 9.

In Step 14, the user creates cut-out orthogonal images of each tooth showing torque 16.

In Step 15, the user creates a montage display of all the teeth cut out orthogonal images showing torque 16 in a constructed panoramic view as shown in FIG. 10.

In Step 16, the user conduct a study of normal subjects or near normal patients to determine an average tip and an average torque to be used as a reference guide for clinical diagnosis and treatment planning.

FIG. 4A is the mesiodistal plane view of an incisor. Anatomical faciolingual plane 9 is perpendicular to anatomical axial plane at crown center level 11 and anatomical axial plane at root center level 12. As noted above, anatomical faciolingual plane 9 crosses perpendicular to anatomical axial plane at root center level 12 at root center 2. Similarly, anatomical faciolingual plane 9 crosses perpendicular to anatomical axial plane at crown center level 11 at crown center 1.

FIG. 4B is the faciolingual view of an incisor. Anatomical mesiodistal plane 10 is perpendicular to anatomical axial plane at crown center level 11 and anatomical axial plane at root center level 12. As noted above, anatomical mesiodistal plane 10 crosses perpendicular to anatomical axial plane at root center level 12 at root center 2. Similarly, anatomical mesiodistal plane 10 crosses perpendicular to anatomical axial plane at crown center level 11 at crown center 1.

FIG. 4C is the axial view at crown center of an incisor. Anatomical mesiodistal plane 10 is perpendicular to anatomical faciolingual plane 9. As noted above, anatomical mesiodistal plane 10 crosses perpendicular anatomical faciolingual plane 9 at crown center 1.

FIG. 4D is the axial view at root center level of an incisor. Anatomical mesiodistal plane 10 is perpendicular to anatomical faciolingual plane 9. As noted above, anatomical mesiodistal plane 10 crosses perpendicular anatomical faciolingual plane 9 at root center 2.

FIG. 5A is the mesiodistal plane view of a molar. Anatomical faciolingual plane 9 is perpendicular to anatomical axial plane at crown center level 11 and anatomical axial plane at root center level 12. As noted above, anatomical faciolingual plane 9 crosses perpendicular to anatomical axial plane at root center level 12 at root center 2. Similarly, anatomical faciolingual plane 9 crosses perpendicular to anatomical axial plane at crown center level 11 at crown center 1.

FIG. 5B is the faciolingual plane view of a molar. Anatomical mesiodistal plane 10 is perpendicular to anatomical axial plane at crown center level 11 and anatomical axial plane at root center level 12. As noted above, anatomical mesiodistal plane 10 crosses perpendicular to anatomical axial plane at root center level 12 at root center 2. Similarly, anatomical mesiodistal plane 10 crosses perpendicular to anatomical axial plane at crown center level 11 at crown center 1.

FIG. 5C is the axial plane view at crown center of a molar. Anatomical mesiodistal plane 10 is perpendicular to anatomical faciolingual plane 9. As noted above, anatomical mesiodistal plane 10 crosses perpendicular to anatomical faciolingual plane 9 at crown center 1.

FIG. 5D is the axial plane view at root center of a molar. Anatomical mesiodistal plane 10 is perpendicular to anatomical faciolingual plane 9. As noted above, anatomical mesiodistal plane 10 crosses perpendicular to anatomical faciolingual plane 9 at root center 2.

FIG. 6 shows a user setting up reference planes at crown center level 11 to determine tip 15 and torque 16. Arch-related faciolingual plane 5 perpendicular to dental arch 4. Arch-related faciolingual plane 5 is perpendicular and intersects arch-related mesiodistal plane 6 at crown center 1.

FIG. 7 shows how tip 15 of an incisor and a molar is measured in the non-anatomical, arch-related mesiodistal plane view. From crown center 1 and root center 2, the projection of long axis 3 can be determined. Tip 15 is the mesiodistal angulation formed by projection of the tooth long axis on the mesiodistal plane 13 and the intersection between arch-related mesiodistal plane 6 and arch-related faciolingual plane 5. If root center 2 is distal to crown center 1, the measurement is positive, otherwise it is negative.

FIG. 8 shows how torque 16 of an incisor and a molar is measured in the non-anatomical, arch-related faciolingual plane view. From crown center 1 and root center 2, the projection of long axis 14 can be determined. Torque 16 is the faciolingual inclination formed by projection of each tooth long axis on the faciolingual plane 14 and the intersection between relative mesiodistal plane 6 and relative faciolingual plane 5. If root center 2 is lingual to crown center 2, the measurement is positive, otherwise it is negative.

FIG. 9 shows a display of each and every tooth tip in a constructed panoramic view orthogonal to arch-related mesiodistal plane 6 of each tooth. As noted above, arch-related faciolingual plane 5 is perpendicular to occlusal plane 7.

FIG. 10 shows a display of each and every tooth torque in a constructed panoramic view orthogonal to arch-related faciolingual plane 6 of each tooth. As noted above, arch-related mesiodistal plane 6 is perpendicular to occlusal plane 7. For each tooth, long axis 3 can be determined by measuring the distance between tooth center 1 and root center 2. Each tooth can be drawn in a panoramic view as indicated.

That which is claimed:

1. A method for measuring and displaying teeth comprising,
locating a crown center of each tooth, which is an intersection an anatomical mesiodistal plane, an anatomical faciolingual plane and an anatomical axial plane;
where the anatomical axial plane is set at crown center level
locating a root center of each tooth which is the intersection of the anatomical mesiodistal plane, the anatomical faciolingual plane and the anatomical axial plane;
where the anatomical axial plane is set at a root center level;
measure a long axis for each tooth by connecting the crown center of each tooth with the root center of each tooth.

2. The method for measuring and displaying teeth of claim 1 further comprising,
drawing a faciolingual plane for each tooth perpendicular to a dental arch through the crown center of each tooth;
drawing a mesiodistal plane for each tooth perpendicular to the faciolingual plane; and
measuring a tip for each tooth, which is mesiodistal angulation formed by projection of the long axis of each tooth on the mesiodistal plane, and the intersection between the mesiodistal plane and the faciolingual plane.

3. The method for measuring and displaying teeth of claim 1 further comprising,
drawing a faciolingual plane for each tooth perpendicular to a dental arch through the crown center of each tooth;
drawing a mesiodistal plane for each tooth perpendicular to the faciolingual plane through the crown center of each tooth; and
measuring a torque for each tooth, which is faciolingual inclination formed by projection of the long axis of each tooth on the faciolingual plane, and the intersection between the mesiodistal plane and the faciolingual plane.

4. The method for measuring and displaying teeth of claim 1 further comprising,
drawing a faciolingual plane for each tooth perpendicular to a dental arch through the crown center of each tooth;
drawing a mesiodistal plane for each tooth perpendicular to the faciolingual plane through the crown center of each tooth;
measuring a tip for each tooth, which is mesiodistal angulation formed by projection of the long axis of each tooth on the mesiodistal plane, and the intersection between the mesiodistal plane and the faciolingual plane;
create cut-out images of each tooth showing the tip of each tooth; and
create a montage display comprising the cut-out images of each tooth showing the tip of each tooth.

5. The method for measuring and displaying teeth of claim 1 further comprising,
drawing a faciolingual plane for each tooth perpendicular to a dental arch through the crown center of each tooth;
drawing a mesiodistal plane for each tooth perpendicular to the faciolingual plane through the crown center of each tooth;
measuring a torque for each tooth, which is faciolingual inclination formed by projection of the long axis of each tooth on the faciolingual plane, and the intersection between the mesiodistal plane and the faciolingual plane;
create cut-out images of each tooth showing the torque of each tooth; and
create a montage display comprising the cut-out images of each tooth showing the torque of each tooth.

6. The method for measuring and displaying teeth of claim 1 further comprising, obtaining viewable three dimensional images of dentofacial structure;
setting up a global coordinate system with a sagital plane, a coronal plane and an occlusal plane;
setting up each tooth-specific coordinate system with the anatomical mesiodistal plane, the anatomical faciolingual plane and the anatomical axial plane;
drawing a dental arch along facial surfaces of teeth at approximately the crown center level;
drawing a faciolingual plane for each tooth perpendicular to the dental arch through the crown center of each tooth;
drawing a mesiodistal plane for each tooth perpendicular to the faciolingual plane through the crown center of each tooth;
measuring a tip for each tooth, which is mesiodistal angulation formed by projection of the long axis of each tooth on the mesiodistal plane, and the intersection between the mesiodistal plane and the faciolingual plane;
measuring a torque for each tooth, which is faciolingual inclination formed by projection of the long axis of each tooth on the faciolingual plane, and the intersection between the mesiodistal plane and the faciolingual plane;
